(19) United States
(12) Patent Application Publication
(10) Pub. No.: US 2026/0044279 A1
(43) Pub. Date: Feb. 12, 2026

(54) Memory Bank Erasure in a Multi-Context Environment

(71) Applicant: TEXAS INSTRUMENTS INCORPORATED, Dallas, TX (US)

(72) Inventors: David P. Foley, Sugal Land, TX (US); Prasanth Viswanathan Pillai, Bangalore (IN); Labeeb K, Bangalore (IN); Naveen Kothuri, Rajahmundry (IN); Jaaneshwaran A, Chennai (IN); Naga Subrahmanyam Tirumala, Bhimavaram (IN)

(21) Appl. No.: 19/223,048

(22) Filed: May 30, 2025

Related U.S. Application Data
(60) Provisional application No. 63/679,693, filed on Aug. 6, 2024.

(51) Int. Cl. G06F 3/06

(52) U.S. Cl. CPC G06F 3/0652; G06F 3/0622; G06F 3/0659; G06F 3/0679

(57) ABSTRACT

A system includes a memory having a memory bank, a memory controller circuit, and an erase logic circuit. A context, running on a processor core, may determine to erase (reinitialize) the memory bank. The context may transmit an indication of the memory bank to be erased to the erase logic circuit. The erase logic circuit may determine immutable address ranges as well as permissions data and may combine data regarding the immutable address ranges with the permissions data. The erase logic circuit may then transmit bits to the memory controller circuit to identify address ranges to be protected from a bank erase operation. The context may then issue a bank erase command to the memory controller, which may erase the memory bank consistent with the bits transmitted from the erase logic circuit.

### CROSS-REFERENCE TO RELATED APPLICATIONS

The present application claims the benefit of U.S. Provisional Patent Application 63/679,693, filed Aug. 6, 2024, the disclosure of which is hereby incorporated by reference in its entirety.

### TECHNICAL FIELD

The present application relates to erasing a memory bank, generally, and more specifically to memory bank erasure in a multi-context environment.

### BACKGROUND

Some systems may include a central processing unit (CPU). The CPU may be in communication with one or more memory controllers. The memory controllers may be configured to provide low-level control of reading and writing to one or more memory circuits.

### SUMMARY

According to an embodiment, a circuit device includes: a processor core; an erase logic circuit coupled to the processor core; and a memory controller circuit coupled to the processor core and to the erase logic circuit, wherein the memory controller circuit is configured to perform read and program operations to a memory bank on behalf of a context running on the processor core, wherein the memory controller circuit is further configured to perform an erase operation on the memory bank on behalf of the context running on the processor core, wherein the erase logic circuit is configured to: receive an indication from the context to begin the erase operation on the memory bank; determine permissions of the context to erase each address range of a plurality of address ranges of the memory bank; determine an immutable address range of the memory bank; transmit data to the memory controller circuit, wherein the data indicates a set of the address ranges to be protected from the erase operation based on the permissions and the immutable address range; and transmit an indication to the context that the erase operation is ready.

According to another embodiment, a method includes: determining to erase multiple sectors of a memory bank by a context, wherein each sector corresponds to a respective memory address range in the memory bank; causing an erase logic circuit to initiate a memory bank erase operation; pausing operation by the context during an elapsed time in which the erase logic circuit initiates the erase operation; receiving, from the erase logic circuit, an indication that the memory bank erase operation has been initiated; resuming operation of the context based on the indication; and causing a memory controller circuit to perform the memory bank erase operation on behalf of the context.

According to another embodiment, a non-transitory computer-readable medium includes computer-executable instructions, which when executed by one or more processor cores causes the one or more processor cores to: cause an erase logic circuit to initiate a memory bank erase operation on behalf of a first context; pause operation by the first context; during a time in which operation of the first context is paused, allow a second context to run; receive, from the erase logic circuit, an interrupt indicating that the memory bank operation has been initiated; resume operation by the first context; and cause a memory controller circuit to perform the memory bank erase operation on behalf of the first context.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example integrated circuit (IC), according to some embodiments;

FIG. 2 is an illustration of an example architecture for an erase logic circuit, according to some embodiments;

FIG. 3 is an illustration of a timeline of an example operation in which a context requests erasure of a memory bank, according to some embodiments;

FIG. 4 is an illustration of an example method, according to some embodiments; and

FIG. 5 is an illustration of an example method, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The present disclosure is described with reference to the attached figures. The figures are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Memory re-initialization (e.g., erasure of memory) is an operation performed by memory controller circuits in multi-context environments. Memory re-initialization ensures that data from a previous context has been erased or otherwise made inaccessible in the memory before a new context can start using this portion of the memory, thus preventing leakage of confidential data. In a security aware environment, only the code running from the particular context may be permitted to trigger the re-initialization of the memory used by that context. Thus, some systems check each time a memory is being re-initialized whether the correct context is issuing the command to erase the memory.

Some memory controller circuits support erase at sector level, and in such examples, sectors may be the smallest memory range which can be erased. Erase operations may specify a single sector or a group of sectors such as all sectors within a memory bank. Further, some memory controller circuits have custom ports to indicate immutable sectors within the bank, often referenced as Immutable Sector Configuration (ISC), to support read-only regions in memory. In an example, an ERASEALL operation may completely re-initialize all the sectors within the memory bank except sectors protected by ISC. The ERASEALL operation may be a faster way of erasing the entire bank when context separation is not a concern. Since the context assignment to each sector in memory is decided during run-time, some systems may support run time re-initialization of memory. Thus, supporting faster run-time memory re-initialization while considering immutability and security features may be desired.

Various embodiments described herein support erase operations directed toward memory banks (e.g., an ERASEALL operation, a type of bank erase operation), where a memory bank may include multiple sectors. Some embodiments may support dynamically changing the input ISC bits through an erase logic circuit and allowing each context to use a bank erase operation in the memory controller to speed up memory re-initialization. In this example, baseline ISC data is maintained that tracks sectors that no context can erase (e.g., truly immutable). When a context initiates a bank erase operation, context-specific ISC data can be added on top of the baseline ISC data to indicate sectors that a particular context cannot erase, for example, because those sectors belong to another context. Example erase logic, described below, may provide baseline ISC and/or context-specific ISC to the memory controller.

Any context which is to erase its used memory content may first request and obtain a semaphore and specify the memory bank in which its content should be erased. A Finite State Machine (FSM) may run which checks whether each sector (or smallest erasable granularity in a memory bank) may be erased by the context in possession of the semaphore. For example, some sectors may be dynamically allocated during runtime to other contexts and, thus, a supervisor may keep a set of permissions indicating which contexts may erase which sectors (e.g., permissions). Once the FSM has checked the entire memory portion (e.g., bank) to be erased against the permissions, the FSM may drive ISC bits (both baseline and context-specific) to the memory controller circuit of the memory bank to be erased. Thus, the resulting, updated ISC bits may contain the baseline ISC information along with the FSM's computed, context-specific result, thus dynamically controlling the re-initialization of sectors.

While a security check for a particular context is ongoing, a processor core may cater to a different context by initializing and/or executing code associated with the latter context, thus saving overhead cost and improving performance. The erase logic circuit may generate an interrupt on which the processor core may jump back to the context that issued the bank erase request. Then the context may request for the bank erase feature in the memory controller to re-initialize all the sectors in the bank together. Since the memory controller uses the ISC signals that include both baseline ISC and context-specific ISC, it erases only allowed sectors for the current context that initiated bank erase operation while other sectors in the bank remain untouched.

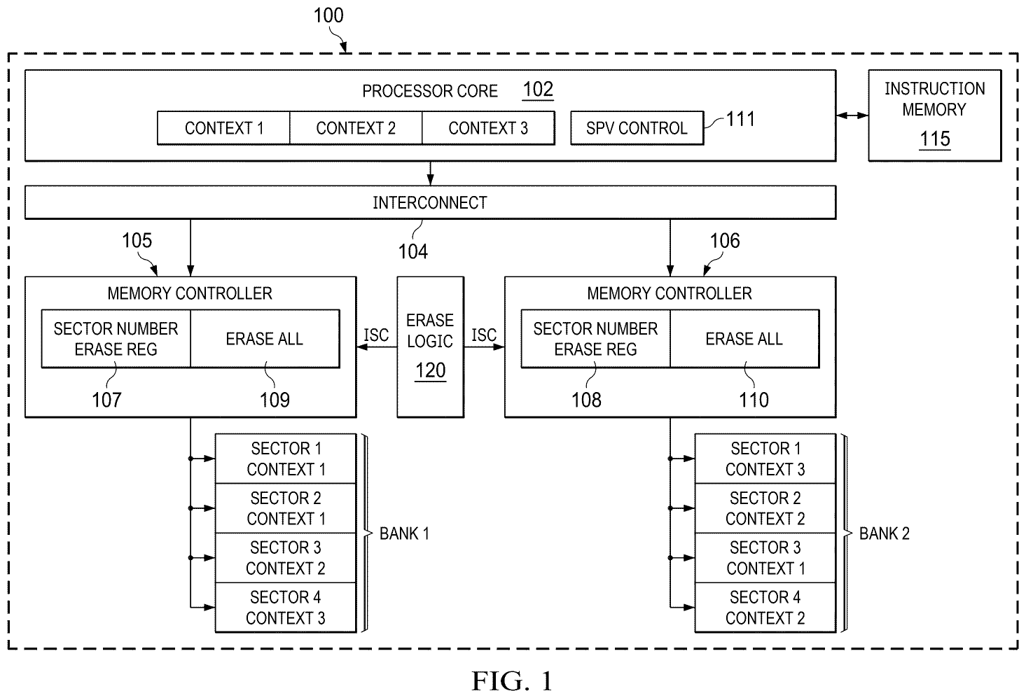

FIG. 1 is an illustration of an example integrated circuit (IC) 100, according to some embodiments. For instance, integrated circuit 100 may be implemented on a semiconductor chip. Integrated circuit 100 includes processor core 102, interconnect 104, memory controller circuits 105, 106, erase logic circuit 120, and flash memory implemented as bank 1 and bank 2. Examples of flash memory include EEPROM, NOR flash, and NAND flash, though the scope of implementations may include any appropriate memory technology. In some implementations, the various components may be implemented on separate semiconductor chips. For instance, another implementation may include processor core 102, interconnect 104, memory controller circuits 105 and 106, and erase logic circuit 120 implemented on a first semiconductor chip while banks 1 and 2 are implemented on a separate semiconductor chip. The various components may be distributed among one or more semiconductor chips as appropriate.

Processor core 102 may be any appropriate type of processor core, such as a central processing unit (CPU), graphics processing unit (GPU), reduced instruction set computer (RISC), and/or the like. Processor core 102 may be implemented as part of a system on-chip (SoC), which includes additional processing circuits (not shown) in some embodiments. While FIG. 1 shows only a single processor core 102, it is understood that various embodiments may include more than one processor core. Instruction memory 115 may store computer-readable instructions for execution by processor core 102. For instance, some or all of the computer-readable instructions to perform the functionality associated with contexts 1-3 and supervisory (SPV) control 111 may be stored in instruction memory 115. Processor core 102 may fetch instructions from instruction memory 115 and execute those instructions during runtime as appropriate.

Interconnect 104 may include conductors, sequential logic circuits, and/or other hardware configured to provide data communication between the processor core 102 and the memory controller circuits 105 and 106. For instance, the processor core 102 may transmit read requests and program requests to the memory controller circuits 105, 106 via the interconnect 104 and may receive acknowledgments and results from the memory controller circuits 105, 106 via the interconnect 104 as well.

Memory controller circuits 105 and 106 may control low-level operations to perform read operations, program operations (e.g., changing bits from 1 to 0), and erase operations (e.g., changing all bits in an address range to 1) on the respective memory banks bank 1 and bank 2. For instance, memory controller circuit 105 may receive a memory address (e.g., a virtual memory address) as part of a read or program operation, and memory controller circuit 105 may perform address decoding to determine a corresponding physical memory address to access particular memory cells within bank 1. For instance, memory controller circuit 105 may read a binary word or multiple binary words, program a binary word or multiple binary words, or erase a binary word or multiple binary words in the bank 1. Memory controller 106 may operate similarly to memory controller circuit 105.

Bank 1 may include a portion of memory. Processor core 102 may execute computer-readable instructions to provide the functionality of one or more computer programs, such as by fetching instructions from instruction memory 115 and executing those instructions. At least some of the data on which the instructions operate may be stored in bank 1. Thus, during execution of a computer program, the processor core 102 may perform read operations and program operations to bank 1, as appropriate, by transmitting read and program requests to memory controller circuit 105. Bank 2 and memory controller 106 may operate similarly.

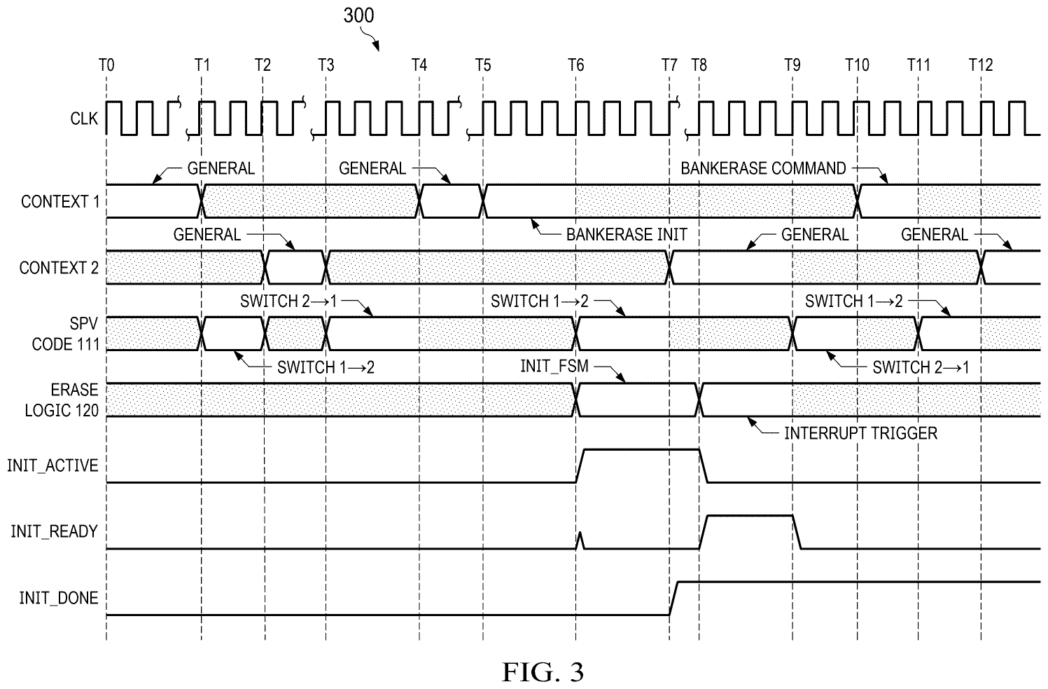

Processor core 102 may execute computer-readable instructions corresponding to the different contexts, shown here as contexts 1-3. Each context may correspond to a different application or a different module of the same application. Furthermore, while only three contexts are shown, various embodiments may include processor core 102 providing simultaneous execution of code corresponding to any appropriate quantity of contexts. SPV control 111 may be performed by processor 102 to provide security and coordination among the contexts 1-3. For instance, SPV control 111 may determine which context may run at a given time, such as illustrated and described in more detail with respect to FIG. 3. SPV control 111 may also allocate different sectors in the banks 1, 2 to the different respective ones of the contexts 1-3, thereby constraining a given context to one or more sectors, which are not shared by other ones of the contexts. In some embodiments, the functionality of SPV control 111 may be implemented in hardware logic, such as may be implemented in processor core 102, in software executed by the processor core 102, and/or in combinations thereof. Various embodiments may include hardware logic and/or software for supervisory functions, SPV code, and/or a combination thereof.

In the present example, SPV control 111 has allocated sectors 1 and 2 of bank 1 to context 1 and has allocated sectors 3 of bank 2 to context 1. Similarly, SPV control 111 has allocated sector 3 of bank 1 and sectors 2, 4 to context 2. SPV control 111 has allocated sector 4 of bank 1 and sector 1 of bank 2 to context 3. Taking context 1 as an example, as a result of the allocations by SPV control 111, context 1 may only read and program from its allocated sectors in banks 1, 2. Such allocations may be referred to as permissions. Accordingly, each context may have its own respective permissions that set out which sectors may be read from or written to (or erased) by that context. Thus, the SPV control 111 may enforce the permissions by allowing read, program, and erase operations that comply with the permissions and may deny read, program, and erase operations that do not comply with the permissions. SPV control 111 may create the permissions during runtime and may dynamically alter the permissions as appropriate.

Each sector in this example represents a range of addresses within a respective bank. For instance, sectors 1-4 of bank 1 may extend from a starting address of bank 1 to an ending address of bank 1, with each sector occupying a non-overlapping range of addresses between the starting address and the ending address of bank 1. Furthermore, while the sectors are illustrated as being equal in size, the scope of implementations may include individual ones of the sectors having a same size or different sizes as appropriate. The sectors 1-4 of bank 2 may be configured similarly.

During operation, a context (e.g., context 1) may determine to erase a sector. In one example, context 1 may request permission to erase sector 1 of bank 1. In this example, sector 1 of bank 1 is allocated to context 1, and SPV control 111 may allow that erase operation to occur. Context 1 may then transmit a sector erase command to memory controller circuit 105 including a starting address of sector 1. For instance, context 1 may write the starting address of sector 1 to the sector number erase register 107. The memory controller circuit 105 may then erase sector 1. However, should context 1 attempt to erase sector 3 of bank 1, SPV control 111 may enforce the permissions by refusing to allow context 1 to erase that sector. Memory controller 106 includes sector number erase register 108 and may operate similarly as the example described above with respect to memory controller circuit 105.

In a scenario in which it may be appropriate for a given context to erase multiple sectors within a bank, IC 100 provides a mechanism for that to happen by including erase logic circuit 120. Erase logic circuit 120 may be implemented in hardware logic in some embodiments. In an example in which context 1 has determined to erase bank 1, context 1 may communicate with erase logic circuit 120. For instance, context 1 may identify bank 1 to erase logic circuit 120. Erase logic circuit 120 may then gather baseline ISC data as well as permission data for context 1 to generate updated ISC data. During a time in which erase logic circuit 120 operates to initiate the bank erase operation, SPV control 111 may pause operation of context 1 and allow other contexts (e.g., context 2 or context 3) to run. Once erase logic circuit 120 has generated the updated ISC data, erase logic circuit 120 may transmit an interrupt to processor core 102, thereby causing SPV control 111 to re-start context 1. Context 1 may then transmit a bank erase command to the erase all logic 109 of memory controller circuit 105. The memory controller circuit 105 may then erase each sector of bank 1 that is not forbidden to be erased by the updated ISC data. Memory controller 106 includes erase all logic 110, which may operate similarly to memory controller circuit 105 and erase all logic 109.

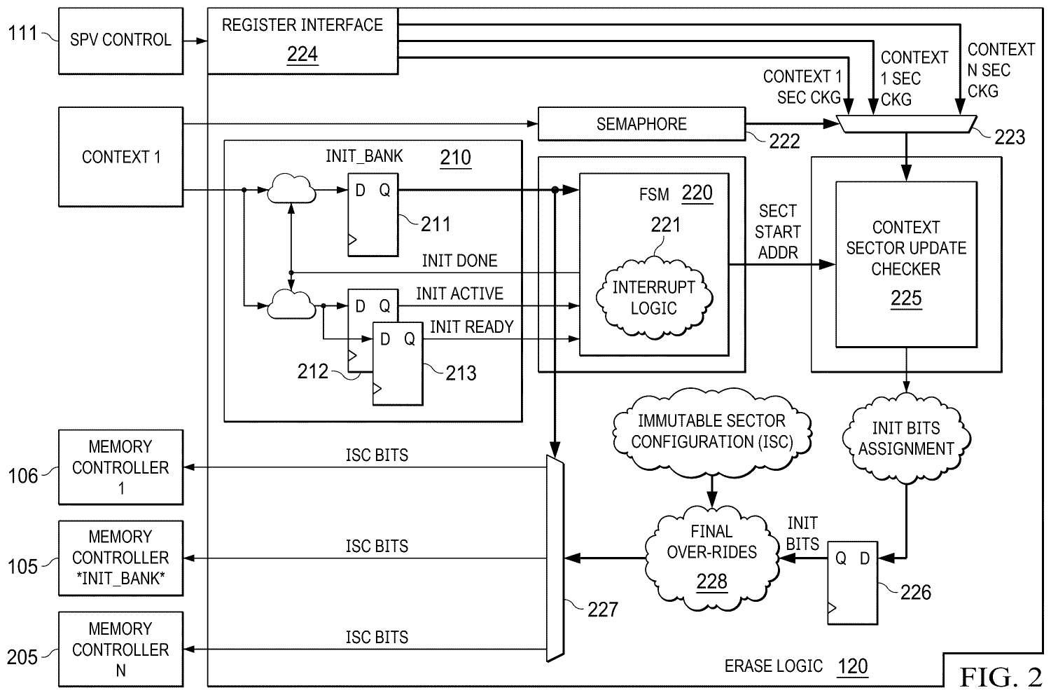

Erase logic circuit 120 is described in more detail with respect to FIG. 2.

FIG. 2 is an illustration of an example architecture for erase logic circuit 120, according to some embodiments. In this example, the various functional blocks of erase logic circuit 120 may be implemented using hardware logic. However, the scope of embodiments may be adapted so that some or all of the functionality described with respect to erase logic circuit 120 may be performed using firmware and/or software.

In this example, erase logic circuit 120 includes initialization bank 210, which includes flip-flops 211-213. The flip-flops 211-213 are in communication with finite state machine 220. The finite state machine 220 is configured to generate address data for various sectors and to provide that address data to the context sector update checker 225.

Further in this example, erase logic circuit 120 includes register interface 224, which is in communication with SPV control 111 to receive data regarding permissions of contexts. The register interface 224 may output that data regarding permissions to a multiplexer 223. Multiplexer 223 may be controlled by semaphore circuitry 222 so that multiplexer 223 outputs permissions based on which context has obtained a semaphore. Multiplexer 223 is configured to output permissions data, for a context that owns the semaphore, to the context sector update checker 225. The output of the context sector update checker 225 may be referred to as initialization bits, and the context sector update checker 225 may output the initialization bits to the flip-flop 226.

Further in this example, the flip-flop 226 may output the initialization bits to the final override logic 228, which may combine the initialization bits with baseline ISC data to generate updated ISC data. Demultiplexer 227 may be controlled by the output of flip-flop 211, which indicates a memory bank or its associated memory controller. Thus, demultiplexer 227 is configured to output updated ISC data to a memory controller that is associated with a memory bank to be erased.

The example of FIG. 2 follows the example of FIG. 1 in that it illustrates how a bank erase command from context 1 may cause a bank erase for bank 1 via the memory controller circuit 105. However, it is understood that the example herein may be adapted for any appropriate context in any appropriate memory bank. Also, while only three memory controller circuits are illustrated (e.g., memory controller circuits 105, 106, 205), it is understood that the scope of embodiments may be scaled for any appropriate number of memory banks and memory controller circuits.

Continuing with the example, context 1 may determine to reinitialize bank 1. To do so, context 1 may gain ownership of (e.g., grab) semaphore circuitry 222. For instance, context 1 may have an identifier to distinguish it from other contexts, and it may write that identifier to the semaphore circuitry 222. Using semaphore circuitry 222 may ensure that only one context at a time may start a bank erase operation. As noted above, the semaphore circuitry 222 may control the output of multiplexer 223 so that permissions associated with context 1 are passed to the context sector update checker 225. The various permissions for each of the contexts may be provided by SPV control 111 in this example.

Context 1 may also write an identity of the bank to be erased to flip-flop 211. Flip-flop 211 may then output that bank identity to the finite state machine 220 and to the demultiplexer 227. The output of flip-flop 211 may trigger the finite state machine 220 to begin operation. The finite state machine 220 is configured to go through the identified bank sector-by-sector. In the example of FIG. 1, context 1 may determine to erase bank 1, and bank 1 includes sectors 1-4, only two of which (sectors 1-2) are allowed to be erased by the permissions of context 1. Once context 1 has written the identity of the bank to flip-flop 211, SPV control 111 may pause operation of context 1 and allow another context to operate during an elapsed time in which erase logic circuit 120 completes generating updated ISC bits.

Finite state machine 220 may begin with a starting address of sector 1 and pass that starting address to context sector update checker 225. In this example, the permissions received through the register interface 224 and multiplexer 223 may indicate a starting address of each respective sector and may indicate whether each respective sector may be written, read, and/or erased by context 1. Context sector update checker 225 may compare the received starting address of sector 1 against the permissions and then output either a yes bit (e.g., a digital 0) or a no bit (e.g., digital 1) as initialization bits to the flip-flop 226.

Finite state machine 220 may then continue the process with sector 2, then sector 3, then sector 4 until all of the sectors in bank 1 have been checked against the permissions of context 1. In the present example, context 1 may have permissions to erase sectors 1 and 2 of bank 1 but not to erase sectors 3 and 4 of bank 1, and that may be reflected in the initialization bits output from the context sector update checker 225.

The final override logic 228 may then combine the initialization bits from flip-flop 226 with the baseline ISC data to generate updated ISC data. The updated ISC data combines the dynamic yes or no from the initialization bits with the baseline ISC data. Baseline ISC data may provide another indication as to which sectors may be written to or erased by a given context. For instance, some sectors may be protected from erasure because they are used for sensitive data, such as cryptographic keys, boot code, and/or the like. Thus, if sector 2 of bank 1 is indicated as protected by the baseline ISC data, then the updated ISC data would indicate that sector 1 may be erased but that the remaining sectors 2-4 may not be erased. This is because sector 2 is protected by baseline ISC data and sectors 3 and 4 are protected by the context-specific permissions.

In one example, the output bits from demultiplexer 227 are hardware signals that are received by the memory controller circuits 105, 106, 205. The demultiplexer 227 may cause updated ISC bits to be transmitted on the hardware signals the memory controller circuit 105 because memory controller circuit 105 corresponds to the bank identified by context 1 at flip-flop 211. Furthermore, demultiplexer 227 may be configured to continue to output baseline ISC bits on hardware signals to the other controllers 106 and 205 to prevent programming or erasing of baseline ISC-protected sectors in the banks corresponding to those memory controllers.

As a result of receiving the updated ISC bits (both baseline and context-specific), memory controller circuit 105 may prevent programming and erasing of sectors 2-4 of bank 1. Upon receiving a bank erase command from context 1, memory controller circuit 105 may then erase all sectors of bank 1 that are not protected by updated ISC bits. In this example, that would be only sector 1.

However, at this point in the example, the context 1 has not yet sent a bank erase command to the memory controller circuit 105. Rather, upon context 1 identifying a memory bank to erase at flip-flop 211, flip-flop 212 may change a state (e.g., from digital 0 to digital 1) of the hardware signal INIT_ACTIVE to indicate to finite state machine 220 that an initialization operation is ongoing and to disallow any erasures of banks while INIT_ACTIVE is asserted. Once the updated ISC bits have been generated and transmitted to memory controller circuit 105, then flip-flop 212 may revert the state (e.g., from digital 1 to digital 0) of the hardware signal For instance, FSM 220 may set the INIT_DONE to high (from a digital 0 to a digital 1) to indicate that the FSM 220 is done configuring. The interrupt logic 221 may use the INIT_DONE signal to clear the INIT_ACTIVE signal and set the INIT_READY signal. In this manner, the state of the INIT_READY hardware signal may change (e.g., from digital 0 digital 1). Once the hardware signal INIT_READY has been asserted, that may cause interrupt logic 221 to send an interrupt to SPV control 111. SPV control 111 may be configured so that when it receives the interrupt from interrupt logic 221, it may resume operation of context 1. Context 1 may be configured to then transmit a bank erase command to memory controller circuit 105. As noted above, upon receipt of the bank erase command, memory controller circuit 105 may then perform a bank erase operation consistent with the updated ISC bits. In an example in which the updated ISC bits indicate more than one sector to erase in a bank, the bank erase command may cause multiple sectors to be erased with the single bank erase command.

FIG. 3 is an illustration of a timeline 300 of an example operation in which context 1 requests erasure of a memory bank, according to some embodiments. FIG. 3 illustrates a system clock (clk), which may be used by either or both of processor core 102 and erase logic circuit 120. The various times T0-T12 may correspond to rising edges of clk in this example.

At time T0, context 1 is running on processor core 102 and performing general processing, which may include issuing read operations and program operations to sectors for which context 1 has permission. Between time T0 and time T1, operation of context 2 is paused. At time T1, SPV control 111 pauses operation of context 1 so that context 2 may run. Thus, by time T2, SPV control 111 has caused context 2 to run on processor core 102, while operation of context 1 is paused. Context 2 runs on processor core 102 between times T2 and T3.

During normal operation, SPV control 111 may determine to switch between operation of context 1 and operation of context 2 as appropriate, such as is illustrated again at time T3, in which SPV control 111 may determine to pause operation of context 2 so that context 1 may resume operation at time T4.

At time T4, context 1 resumes operation and performs general operation until time T5 at which context 1 determines to re-initialize (e.g., erase) a bank. In the example of FIG. 2, context 1 determine to erase bank 1, though the scope of implementations may include multiple other banks and multiple other contexts, and a given context may determine to erase a given bank as appropriate. However, for consistency with the example of FIG. 2, the example of FIG. 3 includes context 1 erasing bank 1.

At time T5, context 1 performs a bank erase initialization. An example is described above with respect to FIG. 2, wherein context 1 gains ownership of semaphore circuitry 222 and also identifies bank 1 to be erased by providing an identifier of bank 1 to flip-flop 211. This may cause the FSM 220 to asserts the signal INIT_ACTIVE at time T6. Processor core 102 may detect that the signal INIT_ACTIVE has been asserted and, in response, SPV control 111 may switch contexts from context 1 to context 2. For instance, SPV control 111 may pause operation of context 1 and resume operation of context 2 at time T7.

Between times T6 and T8, erase logic circuit 120 may generate updated ISC bits, such as described above with respect to FIG. 2. At time T8, erase logic circuit 120 may have completed generating the updated ISC bits, and the state machine 220 may assert the INIT_DONE signal, which may act as a trigger to de-assert INIT_ACTIVE, assert INIT_READY, and issue an interrupt by interrupt logic 221. At time T9, the erase logic circuit 120 may de-asserted the INIT_READY signal.

Context 2 operates between times T7 and T9, and by time T9, the interrupt has caused SPV control 111 to switch contexts again so that context 2 is paused and context 1 is re-started. At time T10, context 1 has resumed operation and has issued an erase command to memory controller circuit 105. At time T8, memory controller circuit 105 may see the updated ISC bits, and at time T10, the memory controller circuit 105 may receive the erase command directed to bank 1. As a result, the memory controller circuit 105 may erase bank 1 consistent with the updated ISC bits.

At time T11, the SPV control 111 may switch contexts again to pause operation of context 1 and re-start operation of context 2 so that context 2 begins operating again at time T12. The following time T12, the SPV control 111 may switch between the contexts 1 and 2 as appropriate.

Thus, as described above with respect to FIGS. 1-3, the process of generating updated ISC bits (both baseline and context-specific) to protect one or more sectors against erasure may be moved to hardware. For instance, erase logic circuit 120 may be implemented using hardware logic, thereby providing an advantageous speed advantage for generating the updated ISC bits versus software. Furthermore, the operation of erase logic circuit 120 may advantageously allow the processor core 102 to allow another context (e.g., context 2) to operate during an elapsed time in which erase logic circuit 120 may generate the updated ISC bits. An example is discussed above with respect to FIG. 3 and times T7-T9. Thus, implementation of erase logic circuit 120, which does not use resources of processor core 102 to generate the updated ISC bits, may advantageously allow for efficiency of operation of the computer system, since context 2 may operate during clock cycles associated with operation of erase logic circuit 120.

Furthermore, a bank erase command may be more efficient than a sector erase command when a context has determined to erase multiple sectors. For instance, in an example in which bank 1 includes more sectors, and more unprotected sectors for erasure by context 1,the bank erase command may allow for a single command to erase multiple sectors, thereby reducing overhead and increasing efficiency of the computer system. By contrast, a system requiring erasure sector-by-sector may incur processing overhead for each sector erase command.

Yet another potential advantage of various embodiments is that the erase logic circuit 120 may advantageously provide appropriate protection against erasure for sectors during runtime. For instance, in the examples of FIGS. 1-3, context 1 may erase a bank during context 1 runtime and context 2 runtime. The erase logic circuit 120 may provide a mechanism to combine context-specific runtime protection data (e.g., the permissions at register interface 224) with baseline ISC data so that only permitted sectors may be erased, even though the context may request erasure of the entire bank via a bank erase command.

Additionally, another potential advantage is that offloading the duties of erase logic circuit 120 to hardware may reduce complexity of code of the SPV control 111. For instance, erase logic circuit 120 may advantageously provide protection of sectors against erasure during a bank erase operation without creating additional burden for SPV control 111.

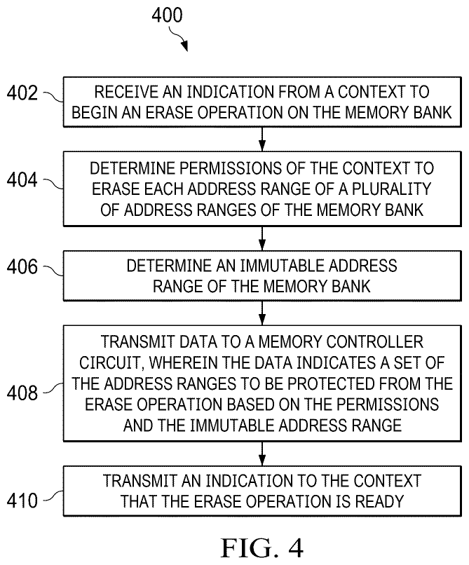

FIG. 4 is an illustration of an example method 400, according to some embodiments. Method 400 may be performed by an erase logic circuit, such as erase logic circuit 120 of FIGS. 1-3.

Action 402 includes the erase logic circuit 120 receiving an indication from a context to begin an erase operation on a memory bank. As an example, the context 1 may identify a bank to erase by writing an identifier the bank to the flip-flop 211, and the context 1 may also take control of the semaphore circuitry 222. Both of these actions may act as an indication to begin the erase operation.

At action 404, the erase logic circuit 120 may determine permissions of the context to erase each address range of a plurality of address ranges of the memory bank. For instance, the erase logic circuit 120 may receive runtime permissions data from SPV control 111 via register interface 224 in FIG. 2. The permissions data may be configured to indicate address range-by-address range permissions of context 1 to erase or not to erase. Further as noted above, the sectors within a memory bank may correspond to address ranges within the memory bank, and the permissions data may identify those address ranges.

In the example of FIG. 2, the FSM 220 and the context sector update checker 225 may go through the address ranges of the bank address range-by-address range and compare those address ranges against the permissions to generate initialization bits, which give a yes or a no to each address range within the identified memory bank.

At action 406, the erase logic circuit 120 may determine an immutable address range of the memory bank. Such immutable address ranges may be indicated in baseline ISC data, as described above. Baseline ISC data may be acquired from any appropriate source, such as from processor core 102, another piece of hardware logic that administers data protection, and/or the like. In any event, the baseline ISC data may indicate address ranges that may not be erased separate from any runtime permissions determined in action 404. Action 406 is not limited to a single immutable address range, as multiple address ranges may be indicated as immutable by baseline ISC data.

At action 408, the erase logic circuit 120 may transmit data to a memory controller circuit to facilitate the bank erase operation. Action 408 may include combining the baseline ISC data with the initialization bits of action 404 to generate, e.g., updated ISC bits. The updated ISC bits may indicate a set of the address ranges to be protected from the erase operation and it may be inclusive of both the runtime permissions and the immutable address ranges.

Action 408 may include transmitting the updated ISC bits to an appropriate memory controller circuit. In this case, the memory controller circuit may correspond to the bank that is the object of the bank erase operation. In the example of FIG. 2, the bank erase operation is directed toward bank 1, which corresponds to memory controller circuit 105, and the demultiplexer 227 may operate to direct the updated ISC bits to the memory controller circuit 105.

At action 410, the erase logic circuit 120 may transmit an indication to the context that the erase operation is ready. For instance, the INIT_READY signal may be asserted by the erase logic circuit 120, which may cause the SPV control 111 to re-start the context 1, thereby indicating to the context 1 that the erase operation is ready and that context 1 may transmit the bank erase command to the memory controller. In other words, action 410 may include an indirect indication to the context at the erase operation is ready, though the scope of embodiments may include a direct indication to the context. The bank erase operation itself, as performed by a memory controller, may include erasing the entire memory bank except for those address ranges protected by the updated ISC bits.

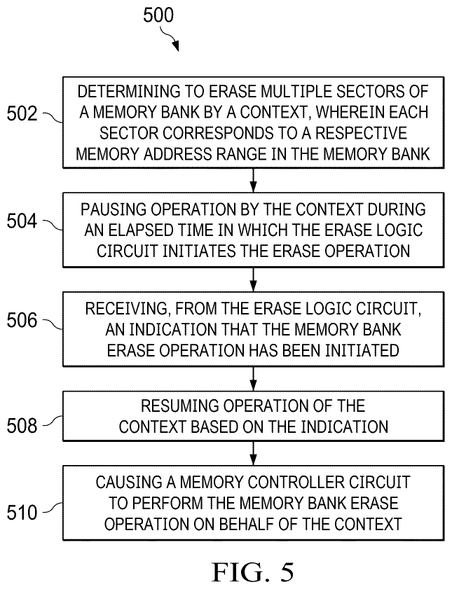

FIG. 5 is an illustration of an example method 500, according to some embodiments. In some embodiments, method 500 may be performed by processor 102, as it runs software code, such as code corresponding to context 1, context 2, context 3, and SPV control 111 of FIG. 1. Thus, the actions of method 500 may be performed by software in some embodiments.

Action 502 includes determining to erase multiple sectors of a memory bank by a context. In the examples above, context 1 determines to erase memory bank 1 rather than erasing a single sector at a time of memory bank 1. In the example of FIGS. 1-3, context 1 initiates a bank erase operation rather than a sector erase operation.

Further in the example of action 502, the multiple sectors each correspond to a respective address range within the memory bank.

At action 504, the software pauses operation of context 1 during an elapsed time in which the erase logic circuit initiates the erase operation. An example is discussed above with respect to FIG. 3, where SPV control 111 pauses operation of context 1 at time T6. The elapsed time for initialization of the erase operation by the erase logic circuit 120 is illustrated as spanning from time T6 to time T8, where the erase logic circuit 120 issues the interrupt to the processor core 102. Action 504 may also include the software re-starting operation of another context, such as context 2. In the example of FIG. 3, the SPV code allows context 2 to operate between times T7 and T9, which overlaps with operation of the erase logic circuit 120.

At action 506, the software receives an indication that the memory bank erase operation has been initiated. In the example of FIG. 3, the erase logic circuit 120 has completed initiating the bank erase operation by generating the updated ISC data, asserting the INIT_READY signal, and issuing the interrupt. At this point, the bank erase operation may be ready for the context 1 to transmit a bank erase command to the memory controller circuit 105.

At action 508, the software resumes operation of the context based on the indication. For instance, the SPV control 111 may pause operation of context 2 and may re-start operation of context 1. Action 508 may be performed in response to the interrupt and/or the INIT_READY signal.

At action 510, the software causes the memory controller circuit to perform the memory bank erase operation on behalf of the context. For instance, the context 1 may issue a bank erase command to the memory controller circuit 105, where the bank erase command indicates that the memory controller should erase the entirety of bank 1. As noted above, the memory controller circuit 105 may have received the updated ISC bits from the erase logic circuit 120, thereby protecting one or more of the sectors in bank 1 from the bank erase operation.

As a result of action 510, the memory controller circuit 105 may erase bank 1 in accordance with any updated ISC bits. Thus, the memory controller circuit 105 may erase bank 1 except for any sectors indicated as being protected by the updated ISC bits. Method 400 and 500 may allow a context, such as context 1, to re-initialize its memory, at least with respect to a memory bank.

The scope of implementations is not limited to the actions of only a single context and a single memory controller. Rather, any of the contexts running on processor core 102 may perform similar bank erase operations with respect to any appropriate memory controller and any appropriate memory bank.

Furthermore, various embodiments may include allowing context 1 to run while initializing the memory bank erase operation. For instance, during the memory bank erase operation, if context 1 is running from random access memory (RAM) or from another flash bank, SPV control 111 may allow context 1 to run, rather than pausing context 1. However, a context (e.g., context 1) may not run from a memory bank while the memory bank is being erased in this example.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A circuit device comprising:
a processor core;
an erase logic circuit coupled to the processor core; and
a memory controller circuit coupled to the processor core and to the erase logic circuit, wherein the memory controller circuit is configured to perform read and program operations to a memory bank on behalf of a context running on the processor core, wherein the memory controller circuit is further configured to perform an erase operation on the memory bank on behalf of the context running on the processor core,
wherein the erase logic circuit is configured to:
receive an indication from the context to begin the erase operation on the memory bank;
determine permissions of the context to erase each address range of a plurality of address ranges of the memory bank;
determine an immutable address range of the memory bank;
transmit data to the memory controller circuit, wherein the data indicates a set of the address ranges to be protected from the erase operation based on the permissions and the immutable address range; and
transmit an indication to the context that the erase operation is ready.

2. The circuit device of claim 1, wherein the erase logic circuit is configured to transmit the data to the memory controller circuit via a plurality of hardware signals.

3. The circuit device of claim 1, wherein the erase logic circuit is configured to determine the permissions by comparing each address range of the plurality of address ranges address range-by-address range against the permissions.

4. The circuit device of claim 1, wherein the erase logic circuit is configured to receive the permissions from supervisory code that is run on the processor core.

5. The circuit device of claim 4, wherein the processor core is configured to run code corresponding to the context, the supervisory code, and an additional context, further wherein the supervisory code is configured to apply different permissions to the context and to the additional context.

6. The circuit device of claim 1, wherein the processor core is configured to pause executing code associated with the context during an elapsed time in which the erase logic circuit determines the permissions and determines the immutable address range, further wherein the processor core is configured to execute code associated with an additional context during the elapsed time.

7. The circuit device of claim 1, wherein the context is configured to transmit an erase command to the memory controller circuit, wherein the erase command specifies erasing the memory bank, further wherein the memory controller circuit is configured to erase at least a portion of the memory bank based on the erase command and based on the data.

8. A method comprising:
determining to erase multiple sectors of a memory bank by a context, wherein each sector corresponds to a respective memory address range in the memory bank;
causing an erase logic circuit to initiate a memory bank erase operation;
pausing operation by the context during an elapsed time in which the erase logic circuit initiates the memory bank erase operation;
receiving, from the erase logic circuit, an indication that the memory bank erase operation has been initiated;
resuming operation of the context based on the indication; and
causing a memory controller circuit to perform the memory bank erase operation on behalf of the context.

9. The method of claim 8, further comprising:
resuming operation of an additional context during the elapsed time.

10. The method of claim 8, wherein resuming operation of the context based on the indication comprises:
receiving an interrupt from the erase logic circuit;
pausing operation of an additional context based on the interrupt; and
resuming operation of the context based on the interrupt.

11. The method of claim 8, wherein causing the erase logic circuit to initiate the memory bank erase operation comprises:
taking control of a semaphore, by the context, to indicate that the context is initiating the memory bank erase operation; and
transmitting, from the context to the erase logic circuit, an indication of a memory bank, from a plurality of memory banks, to be an object of the memory bank erase operation.

12. The method of claim 11, further comprising:
transmitting an indication of permissions of the context to the erase logic circuit based on the context taking control of the semaphore.

13. The method of claim 12, further comprising:
performing read and program operations to the memory bank, by the context, prior to determining to erase the multiple sectors, wherein the read and program operations are performed in compliance with the permissions.

14. The method of claim 8, wherein causing the memory controller circuit to perform the memory bank erase operation is performed during runtime of the context and during runtime of an additional context.

15. A non-transitory computer-readable medium including computer-executable instructions, which when executed by one or more processor cores causes the one or more processor cores to:
cause an erase logic circuit to initiate a memory bank erase operation on behalf of a first context;
receive, from the erase logic circuit, an interrupt indicating that the memory bank erase operation has been initiated; and
cause a memory controller circuit to perform the memory bank erase operation on behalf of the first context.

16. The non-transitory computer-readable medium of claim 15, further comprising instructions to cause the one or more processors to:
pause operation by the first context subsequent to causing the erase logic circuit to initiate the memory bank erase operation;
during a time in which operation of the first context is paused, allow a second context to run; and
resume operation by the first context prior based on receiving the interrupt.

17. The non-transitory computer-readable medium of claim 15, wherein the instructions to cause one or more processors to cause the erase logic circuit to initiate the memory bank erase operation comprises instructions to cause the one or more processors to:
take control of a semaphore, by the first context, to indicate that the first context is initiating the memory bank erase operation; and
transmit, from the first context to the erase logic circuit, an indication of a memory bank, from a plurality of memory banks, to be an object the memory bank erase operation.

18. The non-transitory computer-readable medium of claim 17, further comprising instructions to cause the one or more processors to:
transmit an indication of permissions of the first context to the erase logic circuit based on the first context taking control of the semaphore.

19. The non-transitory computer-readable medium of claim 15, wherein the instructions to cause the one or more processors to cause the memory controller circuit to perform the memory bank erase operation comprises instructions to cause the one or more processors to:
transmit a memory bank erase command from the first context to the memory controller circuit.

20. The non-transitory computer-readable medium of claim 19, wherein the memory bank erase command identifies a memory bank and does not identify addresses within the memory bank to be omitted from the memory bank erase operation.
